(19) United States
(12) Patent Application Publication
(10) Pub. No.: US 2004/0021780 A1
(43) Pub. Date: Feb. 5, 2004

(54) Method and apparatus for automatic photograph annotation with contents of a camera's field of view

(75) Inventor: Dan D. Kogan, Portland, OR (US)

Correspondence Address: Pillsbury Winthrop LLP, Intellectual Property Group, Suite 2800, 725 South Figueroa Street, Los Angeles, CA, 90017-5406, US

(73) Assignee: Intel Corporation, Santa Clara, CA (US)

(21) Appl. No.: 10/210,403

(22) Filed: Jul. 31, 2002

(51) Int. Cl. H04N 5/76

(52) U.S. Cl. 348/231.3

(57) ABSTRACT

A system, apparatus and method for automatically annotating digital images. An electronic capture device captures a digital representation of a scene. An apparatus automatically annotates the digital images with the physical and cultural features that may be included in the image based upon the location of the electronic capture device, and its orientation.

### BACKGROUND OF THE INVENTION

1. Field of the Invention

This invention relates to the field of photograph annotation, and more specifically, to a system, method, and apparatus for automatically annotating digital photographs with the physical and cultural features that may be included in a image based upon the location of the camera, its orientation, as well as parameters internal to the camera.

2. Discussion of the Related Art

There are digital cameras and image-capturing personal digital assistants (“PDAs”) that allow a user to add annotations to photographs. For example, some digital cameras allow a user to type in an annotation/caption for a photograph immediately after the photograph has been taken. However, when a user takes many pictures, it is burdensome for the user to manually write/type a caption for each photograph.

Some digital cameras utilize a global positioning system (“GPS”). GPS can be used to determine the latitude and longitude coordinates of the location where a photograph was taken. Some cameras can annotate photographs with GPS coordinates. Additionally, it is possible to associate a photograph's time stamp with that of a GPS log to deduce the location where a given image was taken even if the camera lacks a built-in GPS device. However, merely annotating an image with the photographer's location is not sufficient to determine what the image might contain. Furthermore, photographs captured at the same location, may contain significantly different subjects if the camera is oriented in different directions. What is needed is an automatic mechanism for annotating digital images with the very features recorded within the camera's field of view (FOV), for example, the names of physical (e.g., mountains, rivers, etc.) and cultural (e.g., buildings, bridges) features that may be contained in the images.

### BRIEF DESCRIPTION OF THE DRAWINGS

FIG. 1 illustrates a method of calculating the field of view according to an embodiment of the invention;

FIG. 2 illustrates a user taking a photograph of a scenic site according to an embodiment of the invention;

FIG. 3 illustrates a process of a user taking photographs at a scenic location and then saving photos, GPS data, and digital compass data in a camera memory according to an embodiment of the invention;

FIG. 4 illustrates a general overview of digital photographs being transferred from a camera and acquiring annotations according to an embodiment of the invention;

FIG. 5 illustrates a method by which digital photographs receive annotations according to an embodiment of the invention; and

FIG. 6 illustrates a digital photograph to which annotations have been added according to an embodiment of the invention.

### DETAILED DESCRIPTION

An embodiment of the present invention describes a system for automatically annotating photographs taken by an electronic capture device such as a digital camera. Further, the present invention concerns a method for automatically annotating digital images with the names of physical and cultural features that may be included in the image. Embodiments of the present invention relate to a digital camera (still or dual mode) that annotates each image with photographic information, such as the lens manufacturer, the focal length of the lens, and the focal distance to the subject. This information is encompassed by the EXIF digital imaging standard (Exchangeable image file format for Digital Still Cameras: Version 2.1 Jun. 12, 1998 Japan Electronic Industry Development Association (JEIDA)) and supported by a majority of emerging middle to high-end digital cameras. The EXIF picture format also provides a way to store the latitude and longitude global position coordinates of the location where a picture was taken. The camera's orientation is also included in the EXIF specification, therefore, cameras with built-in compasses may have that information written into the EXIF JPEG (Joint Photographic Experts Group: ISO/IEC JTC1 SC29 Working Group 1) files the camera creates.

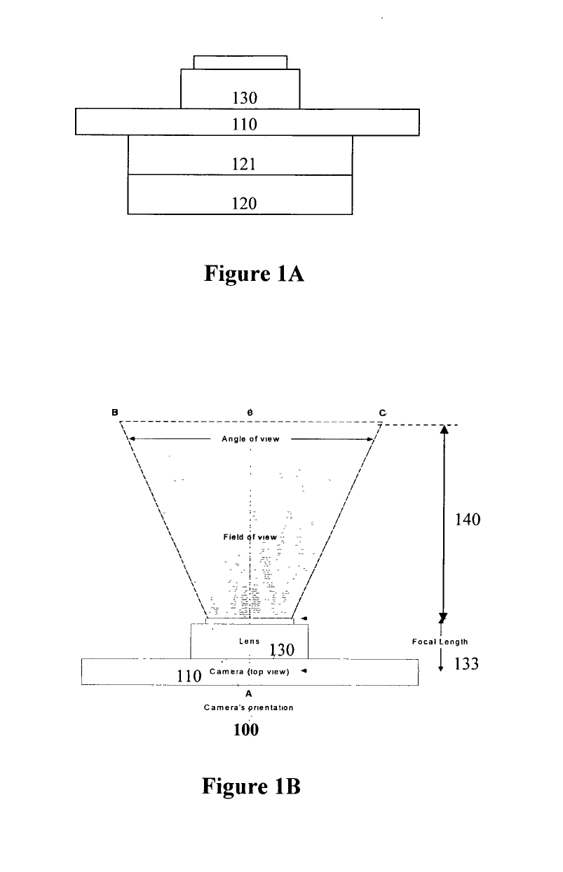

FIG. 1A illustrates a digital camera 110 and lens 130 that may be augmented with both, a GPS unit 120 for determining the global position, and a digital compass 121 for detecting the orientation or bearing of the camera 110 at the time a photo is taken. The digital camera 110 may include an operating system with programmable software allowing the camera 110 to be scripted to send commands to the GPS unit 120 and digital compass 121 through the digital camera's 110 serial port and to embed received data into JPEG images. In this way, the camera's origin and orientation are recorded when pictures are taken.

The images, stored in JPEG format, that includes the EXIF standard, may be uploaded to a computer such as a PC, Macintosh, or Unix workstation in a variety of ways, e.g., through the computer's universal serial bus (USB) port. Once uploaded to a computer, application software in the computer can determine each image's field of view and further annotate the image file with that computed information.

Referring to FIG. 1B, the field of view (FOV) of an image can be determined given the lens focal length 133 and lens 130 manufacturer, and the focal distance 140 to the subject, using application software running on the computer. Both of these pieces of information, the lens focal length 133 and lens 130 manufacturer, as well as the focal distance 140 to the subject, are part of the EXIF standard and are supported by various models of digital cameras.

Mathematical models that map between the 2-dimensional retinal plane of a digital camera and the 3-dimensional physical world are well known in the art. Such models are used by embodiments of the present invention to calculate the location of the edges of a frustum defined by the field of view of the image (line segments AB, AC, and BC below) given (1) the location of the camera 100 within a global coordinate system (e.g., latitude and longitude), and (2) the orientation/bearing of the camera (0-360 degrees).

The field of view, often referred to as the angle of view, may be calculated using the following equation (referring to FIG. 1B):

field of view: W=2 tan⁻¹Y′/2 f

Embodiments of the present invention determine the geographical coordinates and the image's field of view, which may then be used to query a geographical database such as the Geographic Names Information System (GNIF), via the Internet, for the names of physical and cultural features contained within that view.

The GNIF, developed by the United States Geological Survey (USGS) in cooperation with the U.S. Board on Geographic Names (BGN), contains information about almost 2 million physical and cultural features in the United States. The database contains the federally recognized name of each included feature as well as the feature's location by state, county, and geographic coordinates. The GNIS is the nation's official repository of domestic geographic names information. Similar repositories exist for other countries.

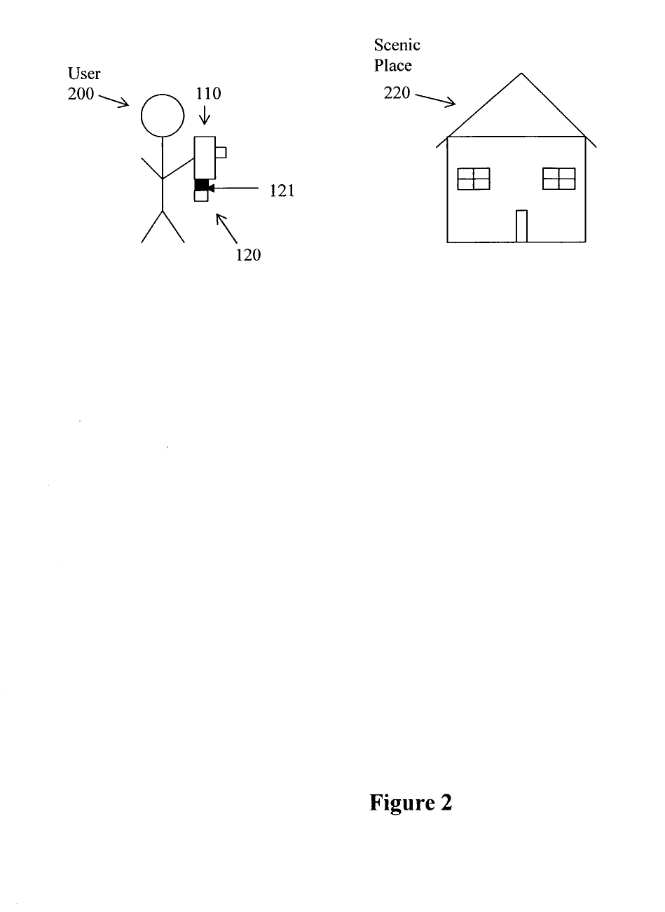

FIG. 2 illustrates a user 200 taking a photograph of a scenic place 220 with an electronic capture device such as a digital camera 110 according to an embodiment of the present invention. In the preferred embodiment, the GPS unit 120 and digital compass 121 are attached to the digital camera 110. In other embodiments, the GPS unit 120, digital compass 121, and the camera 110 may be separate devices. In other embodiments, a digital camera 110 for taking still photographs need not be used. For example, a video camera, or any other suitable device may be used.

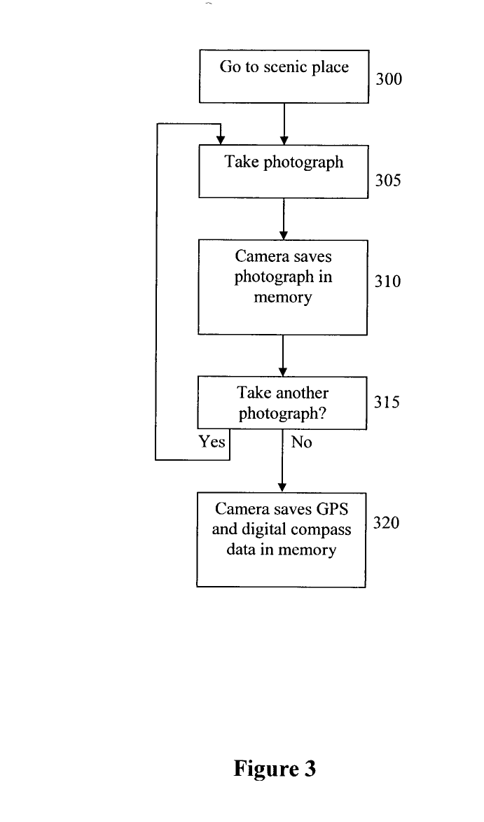

FIG. 3 illustrates a process of a user 200 taking photographs according to an embodiment of the present invention. First, the user 200 brings 300 a camera 110 to a scenic place 220. Next, the user 200 takes a photograph 305 with the camera 110. The camera 110 saves 310 the photograph in a memory, e.g., RAM, flash, HD, CD, DVD, etc. The user 200 may then take 315 another photograph, if desired. The user 200 may continue taking photographs until the user 200 desires to move to a new location. If additional photographs are taken, the same process is repeated, with respect to the taking and saving of photographs.

When the user 200 has finished taking photographs of the scene 220, the camera 110 saves 320 the GPS 120 and digital compass 121 data measured at the time that the photographs were taken in a memory in the camera 110.

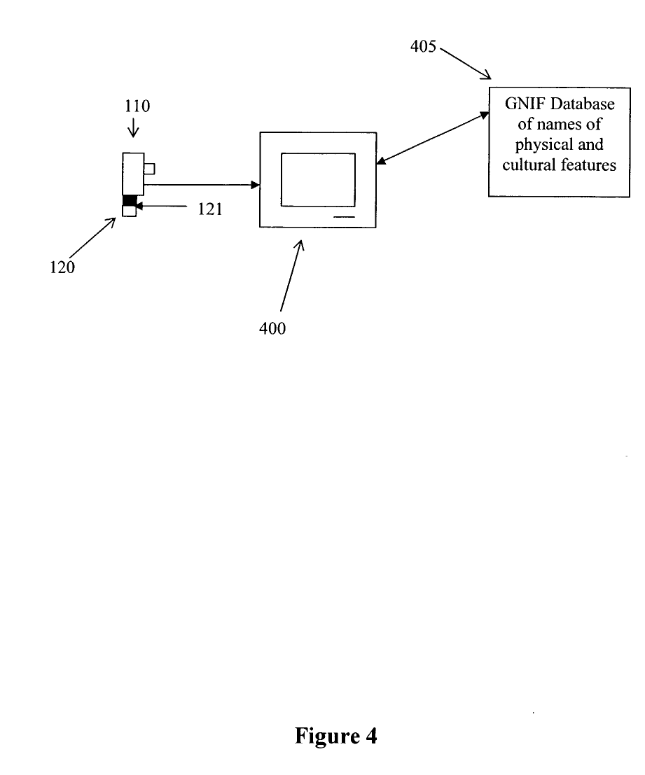

FIG. 4 illustrates a general overview of digital photographs being transferred from the camera 110 and acquiring annotations according to an embodiment of the present invention. As shown, the camera 110 is connected to a computing and communication device such as a computer 400. A program executed by the computer 400 may be used to determine which photographs were taken near which scenic area.

The computer 400 may contact a geographical database such as the Geographic Names Information System (GNIS), via the Internet. In an embodiment of the present invention, the information stored (GPS and compass data) in the digital camera 110 is used to determine the four endpoints of the field of view of each photograph in terms of a global coordinate system, such as latitude-longitude. That information, i.e., the four latitude-longitude pairs, is then used to query the GNIS for all physical and cultural features found within those coordinates. The GNIS 405 then returns all names of physical and cultural features located within that region for a given photo. The application program can then record within the image file the names of the returned features using fields defined in the EXIF standard.

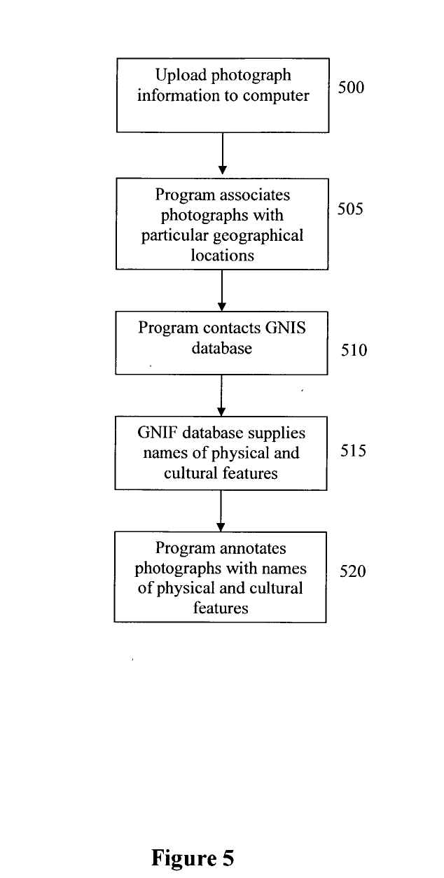

FIG. 5 illustrates a process by which digital photographs receive annotations according to an embodiment of the present invention. First, the user 200 uploads 500 the photograph information to the computer 400 (as discussed above with respect to FIG. 4). Next, the program associates 505 photographs with geographical locations. The program, or another program, contacts 510 the GNIS database. The database GNIS supplies to the computer 515 names of physical and cultural features located within the region for a given photo. The program then annotates 520 the photographs with names of physical and cultural features located within the region for a given photo.

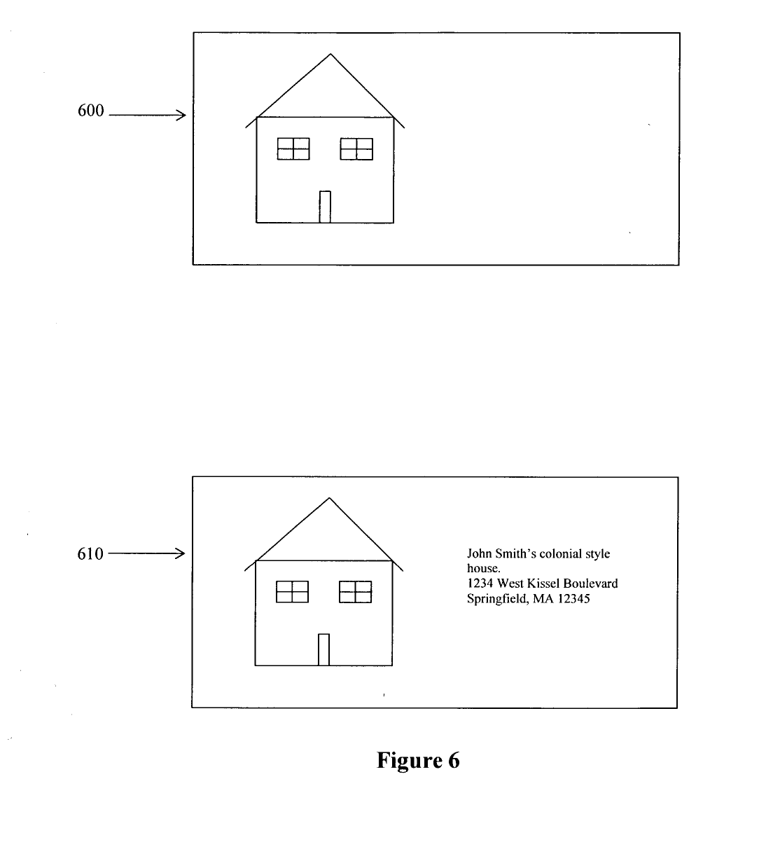

FIG. 6 illustrates a digital photograph to which annotations have been added according to an embodiment of the invention. First, the user 200 takes a photograph 600 of a house, for example. The communication device, i.e. computer 400, contacts the GNIS and receives annotation information. The computer annotates the photograph.

The annotated photograph 610 may read:

John Smith's colonial style house. 1234 West Kissel Boulevard Springfield, Mass. 12345

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A system to automatically annotate a digital image, comprising:
an electronic capture device to capture a digital image of a scene and generate image data;
a geographic location device to generate geographic data based on a location and an orientation of the electronic capture device;
a memory device to record the image data from the electronic capture device and the geographic data from the geographic position device; and
a communication device to communicate with the memory device, wherein the communication device receives the geographic data and the image data, calculates a position of the electronic capture device using the geographic data, calculates positions of features contained within a field of view of the digital image captured by the electronic capture device using the position of the electronic capture device, transmits the positions of the features to a geographical database, receives feature information from the geographical database, and annotates the digital image of the scene with the feature information.

2. The system of claim 1, wherein the electronic capture device is a digital camera.

3. The system of claim 1, wherein the electronic capture device is a video camera.

4. The system of claim 1, wherein the geographic data based on the location and the orientation of the electronic capture device are determined relative to a global coordinate system.

5. The system of claim 4, wherein the geographic location device includes a compass to generate geographic data based on the orientation of the electronic capture device, and a global positioning system (GPS) device to generate geographic data based on the position of the electronic capture device within the global coordinate system.

6. The system of claim 5, wherein the electronic capture device, the GPS device, and the compass form a single unit.

7. The system of claim 5, wherein the compass is a digital compass.

8. The system of claim 1, wherein the memory device is a storage device contained within the electronic capture device.

9. The system of claim 1, wherein the communication device is a computer.

10. The system of claim 1, wherein the communication device is part of the electronic capture device.

11. The system of claim 1, wherein the field of view of the digital image is determined given a lens focal length and a lens manufacturer, and a focal distance to a subject.

12. The system of claim 1, wherein the feature information received from the geographical database includes names of physical and cultural features located within the digital image captured by the electronic capture device.

13. A method of automatically annotating an image, comprising:
capturing a digital image of a scene using an electronic capture device and generating image data;
generating geographic data based on a location of the electronic capture device using a global positioning system (GPS) device;
generating geographic data based on an orientation of the electronic capture device using a compass;
storing the image data from the electronic capture device, the geographic data from the GPS device, and the geographic data from the compass in a database;
communicating with the database using a communication device, wherein the communication device receives the geographic data from the GPS device, the geographic data from the compass, and the image data;
calculating a position of the electronic capture device using the geographic data from the GPS device and the geographic data from the compass;
calculating positions of features contained within a field of view of the digital image captured by the electronic capture device using the position of the electronic capture device;
communicating with a geographical database by the communication device;
transmitting the positions of the features to a geographical database;
receiving, by the communication device, feature information from the geographical database; and
annotating the digital image of the scene with the feature information.

14. The method of claim 13, wherein the electronic capture device is a digital camera.

15. The method of claim 13, wherein the electronic capture device is a video camera.

16. The method of claim 13, wherein the electronic capture device, the GPS device, and the compass form a single unit.

17. The method of claim 13, wherein the compass is a digital compass.

18. The method of claim 13, wherein the database is a storage device contained within the electronic capture device.

19. The method of claim 13, wherein the communication device is a computer.

20. The method of claim 13, wherein the communication device is part of the electronic capture device.

21. The method of claim 13, wherein the geographic data based on the location and the orientation of the electronic capture device are determined relative to a global coordinate system.

22. The method of claim 13, wherein the field of view of the digital image is determined given a lens focal length and a lens manufacturer, and a focal distance to a subject.

23. The method of claim 13, wherein the feature information received from the geographical database includes names of physical and cultural features located within the digital image captured by the electronic capture device.

24. An apparatus to automatically annotate an image, comprising:
an electronic capture device to capture a digital image of a scene and generate image data;
a global positioning system (GPS) device to generate geographic data based on a location of the electronic capture device;
a compass to generate geographic data based on an orientation of the electronic capture device;
a memory device in the electronic capture device to store the image data from the electronic capture device, the geographic data from the GPS device, and the geographic data from the compass; and
a communication device to communicate with the memory device and a geographical database; wherein the electronic capture device, the GPS device, the compass, the memory device, and the communication device are integrated as a unit, the communication device receives the geographic data from the GPS device, the geographic data from the compass, and the image data, calculates a position of the electronic capture device, calculates positions of features contained within a field of view of the digital image captured by the electronic capture device using the position of the electronic capture device, transmits the positions of the features to the geographical database, receives feature information from the geographical database, and annotates the digital image of the scene with the feature information.

25. The apparatus of claim 24, wherein the electronic capture device is a digital camera.

26. The apparatus of claim 24, wherein the electronic capture device is a digital video camera.

27. The apparatus of claim 24, wherein the compass is a digital compass.

28. The apparatus of claim 24, wherein the communication device is a computer.

29. The apparatus of claim 24, wherein the geographic data based on the location and the orientation of the electronic capture device are determined relative to a global coordinate system.

30. The apparatus of claim 24, wherein the field of view of the digital image is determined given a lens focal length and a lens manufacturer, and a focal distance to a subject.

31. The apparatus of claim 24, wherein the feature information received from the geographical database includes names of physical and cultural features located within the digital image captured by the electronic capture device.

32. An article, comprising:
a storage medium having stored thereon instructions that when executed by a machine result in the following
receiving image data of a captured digital image of a scene taken by an electronic capture device;
receiving geographic data from a global positioning system (GPS) device based on a location of the electronic capture device within a global coordinate system;
receiving geographic data from a compass based on a orientation of the electronic capture device within the global coordinate system;
storing the image data from the electronic capture device, the geographic data from the GPS device, and the geographic data from the compass in a database;
calculating a position of the electronic capture device within the global coordinate system using the geographic data from the GPS device, and the geographic data from the compass stored in the database;
calculating positions of features contained within a field of view of the digital image captured by the electronic capture device using the position of the electronic capture device within the global coordinate system;
transmitting the positions of the features to a geographical database
receiving feature information from the geographical database; and
annotating the captured digital image of the scene with the feature information.

33. The article according to claim 32, wherein the electronic capture device is a digital camera.

34. The article according to claim 32, wherein the electronic capture device is a digital video camera.

35. The article according to claim 32, wherein the electronic capture device, the GPS device, and the compass form a single unit.

36. The article according to claim 32, wherein the compass is a digital compass.

37. The article according to claim 32, wherein the field of view of the digital image is determined given a lens focal length and a lens manufacturer, and a focal distance to a subject.

38. The article according to claim 32, wherein the feature information received from the geographical database includes names of physical and cultural features located within the digital image captured by the electronic capture device.
